(19) United States
(12) Patent Application Publication
(10) Pub. No.: US 2012/0221389 A1
(43) Pub. Date: Aug. 30, 2012

(54) System for Promotional Marketing

(76) Inventors: Anil Sharma, Pune (IN); Sachin Ghandi, North Sydney (AU); Rohit Bagad, Mumbai (IN); Sanjay Jambhale, Pune (IN); Rohan Desai, Pune (IN)

(21) Appl. No.: 13/365,243

(22) Filed: Feb. 2, 2012

Related U.S. Application Data
(63) Continuation of application No. PCT/IN2010/000516, filed on Aug. 3, 2010.

(30) Foreign Application Priority Data
Aug. 3, 2009 (IN) 1782/MUM/2009

(51) Int. Cl. G06Q 30/02

(52) U.S. Cl. 705/14.17; 705/14.66; 705/14.32

(57) ABSTRACT

The present invention discloses a system and method for promotional marketing for a group of persons. The system includes an advertiser registration device, an advertiser validation device, a payment facilitation device, a deal creation device, a deal repository device, a matching device, a deal delivery device, a token redemption device and a tracking device The method includes the steps of facilitating the advertisers to create deals for the services by including advertisements, selecting channels for promotion, and setting demographic and geographic preferences, matching the deal preferences and the preferences of the users for effective promotion, delivering the deals to the users after matching the deal preferences and the user preferences using selected channels, enabling users to pay for the services in a cashless manner using tokens, and tracking the deals between users and advertisers.

### CROSS-REFERENCE TO RELATED APPLICATIONS

This application is a continuation of PCT Patent Application Serial Number PCT/IN2010/000516, filed on Aug. 3, 2010, entitled, “System for Promotional Marketing,” which claims priority from Indian Patent Application Serial Number 1782/MUM/2009, filed on Aug. 3, 2009, entitled, “System for Promotional Marketing.”

### FIELD

This invention relates to the information technology.

Particularly, the system relates to a system for aid in marketing.

### DEFINITIONS

In this specification, the following terms have the following definitions as given alongside. These are additions to the usual definitions expressed in the art.

ADVERTISERS: Advertisers include the entities, institutions, organizations, individuals, professionals, dealers, brokers, retailers, providers, producers, manufacturers, consultants and the like interested in promoting a product or a service or goods using the system. Advertiser can also be working on behalf of any organization, entity or corporation for promoting their products, services, or goods.

USERS: Users are the persons, entities, institutions, organizations who are targeted by the system to market, promote or increase the sales of the advertisers. Users include end users who may be corporate users that is the employees of a particular organization pre-registered with the system or individual users who are not registered as employees of any pre-registered organization.

SERVICES: Services are the services provided by the advertisers, organizations, institutions in return of payment. Services also include products or goods provided by the manufacturers, advertisers, organizations, producers and the like.

### BACKGROUND

Any business may be product-oriented or service-oriented. For successful fruition of a business, a strategy of ‘marketing’ is generally adopted. ‘Marketing’ is a methodology or a strategy designed to stimulate a customer to take action towards a buying decision. Promotional marketing is a technique that includes various incentives to buy such as: Contest, Coupons, Free samples, and the like.

It is thus an important aspect to create awareness/interest amongst the public or a niche group of people, and then act on the created awareness by completing a successful sale of the service or product. One method of creating awareness is by means of advertisement through various means.

Advertisers are always on a lookout for an effective means to connect with their Target groups (TG). Advertisers resort to traditional mass promotion mechanism. They get their deals printed either as flyers or as coupon inserts in magazines, food coupons and distribute it to reach their TG. However, all of these mechanisms have no or ineffective targeting facilities build in, are costly and take long to implement. Advertisers do not have a cost effective, multi-channel, self serve, end-to-end platform which connects with TG.

Also there is no system that streamlines the promotion marketing process to target corporate and institutional audience and enhance employee benefits program.

It has been found that if the deals are sent on the mobile which is becoming the new medium of advertisement, the conversion rates are as high as 15-25%. Thus integrated multi-channel targeted engagement model—with the preferred TG not only ensures high conversion rates for promotional ad spend but also ensures the advertisers cost in running such promotions are reduced by reducing the overall rollout time for the deals.

Also, building a network to promote the (contextually matched) deals on 3^{rd} party websites and blogs to find the right consumer will only boost the conversion rates.

Key highlights from study of deals and coupons market in the already established US market and analyzing mobile coupon solution in particular are as follows:

| Highlights | Paper Coupon Campaigns | Mobile coupon |
|---|---|---|
| Implementation Period | 4 to 6 weeks | Few days |
| Implementation charges | 25 to 40 cents per mails | Extremely low |
| | coupons | |
| Average Redemption rates | 1% | 15% TO 25% |
| Subscriber acquisition | $20 to $40 | Extremely low |
| charges | | |
| Offer update | Repetition of entire cycle | Automatic |
| Subscriber Interactivity | Limited | High degree of |
| | | Interactivity |
| Coupo fraud | Several causes and | Eliminated |

### Source: Frost & Sullivan

From the above analysis it is clear that mobile and e-deals are more effective than the traditional mass promotion mechanism like paper coupon and deals platform wishes to provide the same benefits to Indian advertisers by adapting the platform to their needs.

A particular issue with e-deals and mobile deals has been
1) Redemption of deals and Point-of-sales: Redemption Issues: Due to technical issue(s), either it is not possible to scan a 2D or 3D barcode from a wide variety of mobile phones. It is left for the person at point of sales to manually enter the promotional code.
2) Tracking of redemption of deals at the point-of-sales by the promotion marketing platform. In the above case, where the redemption happened through the manual entry of the code at the point of sales, the promotional transaction can be stored and analyzed by the advertiser, there is no mechanism for a promotion marketing platform to get a view of this transaction.

India too is witnessing an increasing growth in the online and mobile marketing. As the mobile subscriber base in India is already 400 million and growing, more and more advertisers are taking this medium seriously. Internet usage will also rise from 45 million to 300 million in next the 3 years.

Traditional mass promotion mechanisms include getting deals printed either as flyers or as coupon inserts in magazines and food coupons and distribute it to the TG. But this lacks or provides a very rudimentary targeting mechanism.

Recently there are many sites and systems that allow deal creation but none of this is targeted at unlocking the corporate and institutional user base. Some of the systems that have been implemented but have similar and other limitations like that provided in United States patent application number 2008086360 which discloses an incentive driven system for advertising. The advertisements are sent on the basis of user preferences to their mobile devices and the system tracks advertisements viewed by the users and gives reward points for viewing the advertisements to be redeemed for future purchases.

The United States Patent Application number 20040117254 discloses a system for distribution of advertisements, sales announcement on mobile handheld devices. However, this application lacks the setup for loyalty points redemption, spending analysis consideration and use of social networking for promotion.

There is therefor a need for a system which works as a platform and aims to overcome this challenge for the advertisers and corporate bodies.

### OBJECTS

Some of the objects of the present disclosure are as follows:

An object of the disclosure is to provide a multi-channel system for marketing.

Another object of the disclosure is to provide a marketing system that helps target specific user base of corporate employees and enables companies to enhance their employee benefits program by offering deals and offers against employee points.

Yet another object of the present disclosure is to provide a system which allows users to create social wish list request for availing group discount.

Still another object of the present disclosure is to provide a solution to a key challenge of Track deal/offer redemption at point of sales.

### SUMMARY

In accordance with an aspect of the present disclosure there is provided a system for promotional marketing for a group of persons comprising:
a virtual platform accessible by a group of users and a group of advertisers wherein the advertisers promote their services by selectively sending advertisements comprising deals through various channels to said users;
user registration means adapted to register users on said platform via a remote device using the internet or a mobile network through emails, SMS, or WAP;
user validation means adapted to validate said users;
user repository means adapted to store personal details and preferences set by users during registration after validation;
advertiser registration means adapted to register advertisers on said platform via a remote device using the internet or a mobile network through emails, SMS, or WAP;
advertiser validation means adapted to validate said advertisers;
payment facilitation means adapted to allow said advertisers to select payment options including pricing models and credit limits and further adapted to enable advertisers to pay for deals to be created;
deal creation means adapted to facilitate said advertisers to create deals in advertisements, selecting channels for promotion, and setting demographic and geographic preferences;
deal repository means adapted to store deals created by various advertisers for further retrieval;
matching means adapted to fetch data from said deal repository means and said user repository means and further adapted to match the deal preferences and the preferences of users for effective promotion;
deal delivery means co-operating with said matching means, said deal delivery means adapted to deliver deals to users after matching the deal preferences and user preferences using the channels selected by advertisers;
token redemption means adapted to enable users to pay for services in a cashless manner using tokens; and
tracking means co-operating with said token redemption means and said deal delivery means, said tracking means adapted to track deals between users and advertisers.

Typically, validation of a user is done by sending validation code containing message on the user's mobile device and allowing the user to enter the code on the platform.

Typically, the channel for sending deals is selected from the group consisting of emails, SMS, WAP, GPRS, and EDGE.

Typically, said payment facilitation means includes receipt generation means adapted to generate and provide receipts for successful payments and is further adapted to authenticate advertisers to enable them to create deals.

Typically, said platform is a web page.

Typically, said token redemption means is a loyalty points redemption means adapted to redeem loyalty points accumulated by an employee.

Typically, said token redemption means is adapted to redeem mobile coupons containing barcodes corresponding to deals.

Additionally, said token redemption means is adapted co-operate with a credit/debit card company to redeem mobile coupons by crediting the redemption amount into the account of a user, wherein a redemption code is generated at the advertiser's retail store corresponding to a mobile coupon containing a deal.

Typically, the system includes a wish list facilitation means adapted to allow users belonging to an organization to create, join, and un-join wish lists to seek group discounts.

Typically, the deal delivery means comprises deal approval means adapted to approve deals to be sent for promotions using any of the channels.

Typically, said deal delivery means is adapted to send a deal using the email and SMS channel, said deal delivery means including batch process means adapted to push deals automatically using an email server and a 3^{rd} party SMS push gateway.

Typically, said deal delivery means is adapted to send deals using a WAP channel, said deal delivery means including
requesting means adapted to accept a request for deal information made by users using WAP applications on their mobile devices; and
batch processing means adapted to push deals automatically using WAP push means.

Typically, the deal delivery means is adapted to send a deal using a web channel, said deal delivery means including
requesting means adapted to accept a request for deal information made by a user using a web interface; and
batch process means adapted to push deals automatically using a web push means.

The deal delivery means also comprises an external promotion facilitation unit including
registration means adapted to register 3^{rd} party interfaces including websites and blogs on said platform;
deal script generation means adapted to generate scripts to display deals on said 3^{rd} party interfaces; and
deal script trigger and display means adapted to display deals on 3^{rd} party interfaces on a user access trigger.

Typically, said deal delivery means includes
social networking means adapted to promote deals using social networking and micro blogging sites like twitter, Facebook and orkut;
RSS/ATOM feeds facilitation means adapted to promote deals using RSS/ATOM feeds to be read by users using any standard feed reader;
instant messaging facilitation means adapted to promote deals using various instant messengers and internet relay chatting servers; and
plug-in support means adapted to promote deals via dedicated plug-in gadgets.

In accordance with another aspect of the present invention a method for promotional marketing for a group of persons comprising the following steps:
providing a virtual platform accessible by a group of users and a group of advertisers wherein the advertisers promote their services by selectively sending advertisements comprising deals through various channels to the users;
registering users on said platform via a remote device using the Internet or a mobile network through emails, SMS, or WAP;
validating said users;
storing the personal details and preferences set by users during registration, after validation;
registering advertisers on said platform via a remote device using the internet or a mobile network through emails, SMS, or WAP;
validating the advertisers;
enabling advertisers to select payment options including pricing models and credit limits and methods of paying for deals to be created;
facilitating the advertisers to create deals by advertising, selecting channels for promotion, and setting demographic and geographic preferences;
storing the deals created by various advertisers for further retrieval;
fetching data from said deal repository means and said user repository means;
matching the deal preferences and the preferences of users for effective promotion;
delivering deals to users after matching deal preferences and user preferences using channels selected by the advertisers;
enabling users to pay for the services in a cashless manner using tokens; and
tracking the deals between the users and the advertisers.

Typically, the step of enabling user to pay for the services in a cashless manner includes using loyalty points for corporate users and further includes the following steps
tracking an employee's accumulated loyalty points;
using said accumulated points for payment; and
reconciling the payments with the employee at the end of the month.

Typically, in the step of enabling a user to pay for services in a cashless manner includes using tokens for individual users and further includes the following steps:
valuing tokens; and
compensating the value of said tokens.

Typically, the step of enabling a user to pay for the services in a cashless manner includes using a redemption code for credit/debit card users and includes the following steps:
generating a redemption code at the advertiser's retail store corresponding to a mobile coupon; and
entering the redemption code at the credit/debit card website for crediting the amount into the credit/debit card account.

Typically, the step of enabling a user to pay for the services in a cashless manner is used for credit/debit card users and includes the following steps;
generating a redemption code at the advertiser's retail store corresponding to a mobile coupon containing a deal; and
entering the redemption code on the platform for crediting the amount into the credit/debit card account.

### BRIEF DESCRIPTION OF THE ACCOMPANYING DRAWINGS

Other aspects of the invention will become apparent by consideration of the accompanying drawings and their description stated below, which is merely illustrative of a preferred embodiment of the invention and does not limit in any way the nature and scope of the invention:

FIG. 1 illustrates a system for promotional marketing for a group of persons as envisaged by the present invention;

FIG. 2 illustrates a detailed view of deal delivery means used for using different channels as envisaged by the present invention;

FIG. 3 illustrates a method for promotional marketing for a group of persons as envisaged by the present invention;

### DETAILED DESCRIPTION

The invention will now be described with reference to the accompanying drawings which do not limit the scope and ambit of the disclosure. The description provided is purely by way of example and illustration.

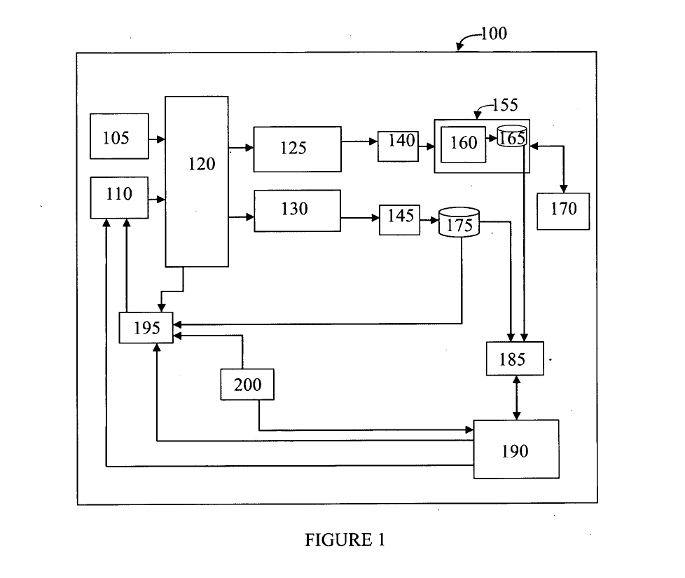

Referring to FIG. 1 there is shown a block diagram of the system 100 for promotional marketing for a group of persons. The advertisers 105 can promote the products using this system after registration payment of nominal fee. The registration of the advertisers is done using a platform 120 which acts as link between the advertiser and the advertiser registration means 125. Advertiser registration means 125 registers advertiser with the system by cooperating with the administrative means (not shown in the figure) handled by an administrative team. Further the advertisers are validated by the advertiser validation means 140 which checks compliance and acceptance of certain predetermined online agreements. After the advertisers are registered and validated the advertisers are required to pay using the system for promotion of their products or services. This is done using payment facilitation means 170 which based on the advertiser category, pricing model, approved credit limit, and related banking information filled during registration collects the agreed sum of operational cost and a receipt is generated using receipt generation means (not shown in the figure). For instance there could be payment based on monthly billing instead of pre-paid model. Various pricing options like listing based, action-based impression or per click based (CPM/CPC), platform usage fee are provided.

Post payment, advertisers can create deals and target them to desired group (corporate users or individual users) geographically and demographically, the deals are created using deal creation means 155 which allows the advertisers to create deals by facilitating organization of the advertisements, selection of channels for promotion and consideration of discounts and tokens. The deals created are stored in the deal repository means 165 which is adapted to store deals created by various advertisers for further retrieval and use in a batch process.

The platform 120 also performs user registration of the users which are then selectively targeted by the advertisers for promoting their products or services as per users' preference. A user generally represented by reference numeral 110 is registered using the platform 120 which connects the user to the user registration means 130 which lets the user fill in personal data like his/her name, postal address, phone number as well category preferences, time and volume preferences. This information is then stored into the user repository means 175 after validation of the user using user validation means 145. The validation of the user is done by sending a message to the user's mobile device which contains the validation key obtained from a code generation server which the user needs to feed on the platform in order to validate. The mobile device can be any handheld wireless device like mobile phone, PDA, IPOD, IPAD, and the like.

The system supports two kinds of users, individual users and corporate users or employees of any organization pre registered with the system. In case of corporate bodies, the deals' platform integrates with an HRMS database for tracking of employee loyalty points for redemption which are also stored in the user repository means 175.

Further a matching means 185 is used for matching users and deals as per the demographic & geographic target information, budget set by advertisers and time, volume & category preferences set by users. Mixed & matched data is then used by deal delivery means 190 which as per the advertiser selected channel, sends the deals to the users. The deal delivery means 190 also includes deal approval means (not shown in the figure) adapted to approve the deal data to be sent for promotion using a batch process means (not shown in the figure) adapted to push the deals using selected channel automatically as a batch process. Batch process means also considers the deal history and end user history while creating the batch data.

Further, a token redemption means 195 is used to redeem mobile tokens containing barcodes and the like codes for giving discounts at the advertiser specified stores, in case of individual users.

For instance a user takes his mobile coupon with the barcode to the advertiser's retail shop. The advertiser scans the barcode with a scanner and validates if the coupon is valid. If yes it will redeem the coupon.

Another instance can be of a QR code reader on the user's mobile device can capture the deal information by reading the QR code displayed either on the web listing or the print poster. This deal information on the user's mobile device is used at the advertiser's retail store for the deal redemption.

Still another instance can be of mobile coupons containing deals offered by credit card/debit card companies for various products/services/goods at selected stores to promote use of their credit card/debit card. These coupons are shown by users at the advertiser's retail store at the time of a payment and the user is given a redemption code along with the payment receipt or invoice which has to be fed at the corresponding credit/debit cards website along with account and card no. for redemption, the back end system of the card company then co-operates with the token redemption means 195 to authenticate and authorise redemption payment and the amount is credited directly into the user's account.

Also it is within the scope of the invention to let the user enter details (redemption code) of the transaction on the platform 120 instead of logging-in to Credit Card company website. After entering the details the platform initiates the token redemption means 195 to cooperate with retailers backend system and authenticate and authorize redemption payment of the transaction and instruct the backend system to initiate refund amount equal to discount through their own interfaces with the credit card company.

Both of these cases allows the promotion marketing platform to track a point of sales redemption for further market research. It is also within the scope of the invention to facilitate such redemption with the privilege accounts of the users opened with the manufacturers, producers, sellers, dealers, and advertisers like frequent flyer account with airways.

The tracking is done using a tracking means 200 which co-operates with the deal delivery means 190 and token redemption means 195 to analyze the deals and redeemed tokens.

In accordance with the invention these mobile coupons are sent to the users mobile devices or other handheld devices after consideration of spending analysis of the user with the brand or company who's products or services are being promoted. This data of spending analysis is also fed in by the advertisers at the time of registration.

In the case of corporate users, loyalty points stored in the user repository 175 are redeemed and the advertiser reconciles the redeemed loyalty points amount with the employer at the end of the month.

In accordance with another embodiment of the present invention users can make wish lists for products/services/goods using wish list creation means (not shown in the figure) and allow other users to join in case they are also interested in same products and such a pool of employees can ask for group discounts from the advertisers. For instance the creation of a wish list can be done at the time of registration of a corporate user or after that and other corporate users belonging to same company or conglomerate are invited to join the wish list in case they are interested in same products, this data pertaining to the users wish list is stored in the user repository means 175.

In accordance with still another embodiment of the present invention four different types of channels are used for sending the deals to the users: email, short messaging (SMS), wireless application protocol (WAP), web, and 3^{rd} party website/blog post. Also, micro-blogging and social networking are used to promote advertisements using the easiest, cheapest and most effective way.

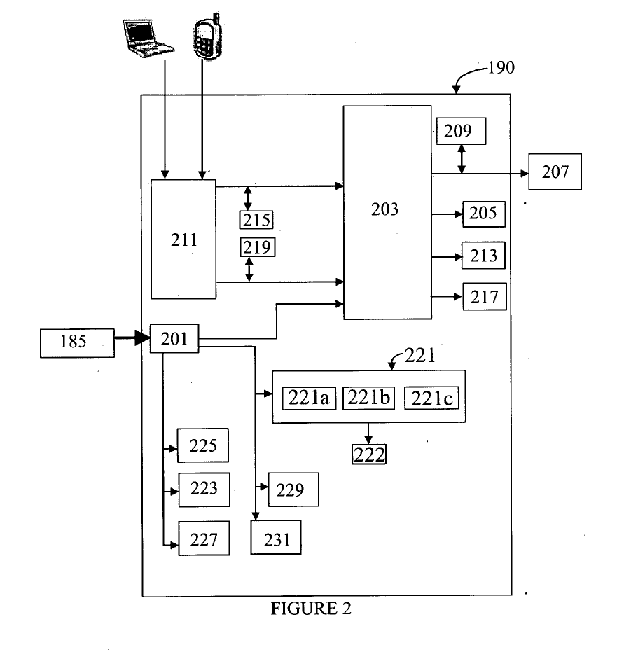

Referring to FIG. 2 there is shown deal delivery using different channels In accordance with the present invention where the deal delivery means 190 is adapted to send the deals using different channels as per the advertisers' selection. Every deal to be sent is first approved by the deal approval means 201 and sent further for sending via different channels.

In cases where the advertisers and users both opt for email channel and/or SMS channel the right deals are taken from matching means 185 and are sent to the batch process means 203 which pushes it to the email Server 205 and 3^{rd} Party SMS push gateway 207 is used to pass the deal to the user. Respective report servers 209 are updated after each batch process.

For WAP channel, a requesting means 211 receives user entered information using a Rich/WAP application on his/her mobile device requesting for various deals. Request is fulfilled by deal delivery means 190 which coordinates with the matching means 185 to identify right deals and then the deal is passed to batch process means 203 which forwards the same to user's handset using WAP push means 213. Respective report servers, collectively represented by 215 are updated accordingly.

For Web channels, a requesting means 211 receives user entered information using a Web interface. A request is fulfilled by a deal delivery means which coordinates with the matching means 185 to identify right deals and then the deal is passed to batch process means 203 which forwards the same to users web interface using web push means 217. Respective report servers 219 are updated accordingly. Also, in this case deal based action means (not shown in the figure) is used by users to save, print, refer, and set reminder deals. Each action is tracked by the system.

For website/blog post, an external promotion facilitation unit 221 is used which includes registration means 221a adapted to register 3^{rd} party interface including a website or blogs on said platform. During registration the category preferences of advertisements and the like preference information can be selected and banking information for payments is provided. Further a deal script generation means 221b is provided which is adapted to generate scripts to display said deals on 3^{rd} party interfaces. Scripts are generated for various banner sizes or plain text deals can be generated and the same can be placed on respective available slots on 3^{rd} party websites/blogs. A deal script trigger and display means 221c is provided which is adapted to display the deal on the 3^{rd} party interface on a user access trigger i.e. anyone visiting the site/blog will trigger the deal script. On a trigger the deal request means will fetch the preference data provided during registration and run the contextual match on preferred deals. All respective report servers 222 get updated.

For micro-blogging like twitter a micro-blogging means 223 is used which promotes every valid deal on twitter via official account of advertisers, this will act as an alert mechanism for all followers

For social networking promotion, a social networking means 225 is provided which is adapted to promote deals using social networking and micro blogging sites like twitter, Facebook and orkut.

For RSS/ATOM feeds based promotion, a RSS/ATOM feed facilitation means 227 is provided for promotion of deals using RSS/ATOM feeds to be read by users using any standard feed reader; and in the case of instant messaging an instant messaging facilitation means 229 is provided which is adapted to promote deals using various instant messengers and internet relay chatting servers.

For dedicated plug-in support a plug-in support means 231 is provided which is adapted to promote deals via dedicated plug-in, gadgets like iGoogle gadget, Yahoo Widget, Firefox plugin, Widset, and the like.

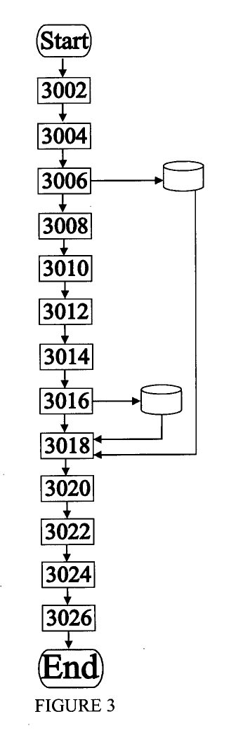

In accordance with still another embodiment of the present invention a method for promotional marketing for a group of persons is envisaged. Referring to FIG. 3 the method is shown which comprises the steps of:
providing a virtual platform accessible by a group of users and a group of advertisers wherein the advertisers promote their services by selectively sending deals comprising advertisements through various channels to the users, 3002;
registering users on the platform via a remote device using the internet or the mobile network through emails, SMS, or WAP;
validating the users, 3004;
storing the personal details and the preferences set by the users during registration, after validation, 3006;
registering advertisers on the platform via a remote device using the internet or the mobile network through emails, SMS, or WAP, 3008;
validating the advertisers, 3010;
selecting payment options including pricing model and credit limit and pay for deals to be created, 3012;
facilitating the advertisers to create deals for the services by including advertisements, selecting channels for promotion, and setting demographic and geographic preferences, 3014;
storing the deal created by various advertisers for further retrieval, 3016;
fetching data from the deal repository means and the user repository means, 3018;
matching the deal preferences and the preferences of the users for effective promotion, 3020;
delivering the deals to the users after matching the deal preferences and user preferences using the advertiser selected channel, 3022;
enabling users to pay for the services in a cashless manner using tokens, 3024; and
tracking the deals between the users and advertisers, 3026.

In accordance with a still further an embodiment of the present invention the step of enabling user to pay in a cashless manner is used for corporate users and includes the steps of
tracking employee accumulated loyalty points;
using said accumulated points for the payment; and
reconciling the payments with the employee at the end of the month.

In accordance with one more embodiment of the present invention the step of enabling user to pay in a cashless manner is used for individual users and includes the steps of
valuing mobile coupons; and
compensating for the value of said mobile coupons.

In accordance with still one more embodiment of the present invention the step of enabling user to pay for the services in a cashless manner uses tokens and is used for credit/debit card users and includes the steps of
generating a redemption code at the advertiser's retail store corresponding to a mobile coupon containing the deal; and
entering the redemption code at the credit/debit card website or on the platform for crediting the amount into the credit/debit card account.

### Technical Advancements:

Technical advancements of the present invention include in providing
a multi-channel system for marketing;
a marketing system that helps target specific user base of corporate employees and enables companies to enhance their employee benefits program by offering deals and offers against employee points;
a system which allows users to create social wish list request for availing group discount; and
a solution to a key challenge of Track deal/offer redemption at point of sales.

While considerable emphasis has been placed herein on the particular features of this invention, it will be appreciated that various modifications can be made, and that many changes can be made in the preferred embodiments without departing from the principles of the invention. These and other modifications in the nature of the invention or the preferred embodiments will be apparent to those skilled in the art from the disclosure herein, whereby it is to be distinctly understood that the foregoing descriptive matter is to be interpreted merely as illustrative of the invention and not as a limitation.

1. A system for promotional marketing for a group of persons comprising:
a virtual platform accessible by a group of users and a group of advertisers wherein the advertisers promote their services by selectively sending advertisements comprising deals through various channels to said users;
user registration means adapted to register users on said platform via a remote device using the internet or a mobile network through emails, SMS, or WAP;
user validation means adapted to validate said users;
user repository means adapted to store personal details and preferences set by users during registration after validation;
advertiser registration means adapted to register advertisers on said platform via a remote device using the internet or a mobile network through emails, SMS, or WAP;
advertiser validation means adapted to validate said advertisers;
payment facilitation means adapted to allow said advertisers to select payment options including pricing models and credit limits and further adapted to enable advertisers to pay for deals to be created;
deal creation means adapted to facilitate said advertisers to create deals in advertisements, selecting channels for promotion, and setting demographic and geographic preferences;
deal repository means adapted to store deals created by various advertisers for further retrieval;
matching means adapted to fetch data from said deal repository means and said user repository means and further adapted to match the deal preferences and the preferences of users for effective promotion;
deal delivery means co-operating with said matching means, said deal delivery means adapted to deliver deals to users after matching the deal preferences and user preferences using the channels selected by advertisers;
token redemption means adapted to enable users to pay for services in a cashless manner using tokens; and
tracking means co-operating with said token redemption means and said deal delivery means, said tracking means adapted to track deals between users and advertisers.

2. The system as claimed in claim 1, wherein said user validation means is further adapted to validate a user by sending a validation code containing a message on the user's mobile device and still further adapted to allow the user to enter the code on said platform.

3. The system as claimed in claim 1, wherein said channel is selected from the group consisting of emails, SMS, WAP, GPRS, and EDGE.

4. The system as claimed in claim 1, wherein said payment facilitation means includes receipt generation means adapted to generate and provide receipts for successful payments and is further adapted to authenticate advertisers to enable them to create deals.

5. The system as claimed in claim 1, wherein said platform is a web page.

6. The system as claimed in claim 1, wherein said token redemption means is a loyalty points redemption means adapted to redeem loyalty points accumulated by an employee.

7. The system as claimed in claim 1, wherein said token redemption means is adapted to redeem mobile coupons containing barcodes corresponding to deals.

8. The system as claimed in claim 1, wherein said token redemption means is adapted co-operate with a credit/debit card company to redeem mobile coupons by crediting the redemption amount into the account of a user, wherein a redemption code is generated at the advertiser's retail store corresponding to a mobile coupon containing a deal.

9. The system as claimed in claim 1, wherein the system includes a wish list facilitation means adapted to allow users belonging to an organization to create, join, and un join wish lists to seek group discounts.

10. The system as claimed in claim 1, wherein the deal delivery means comprises deal approval means adapted to approve deals to be sent for promotions using any of the channels.

11. The system as claimed in claim 1, wherein said deal delivery means is adapted to send a deal using the email and SMS channel, said deal delivery means including batch process means adapted to push deals automatically using an email server and a 3^{rd} party SMS push gateway.

12. The system as claimed in claim 1, wherein said deal delivery means is adapted to send deals using a WAP channel, said deal delivery means including
requesting means adapted to accept a request for deal information made by users using WAP applications on their mobile devices; and
batch processing means adapted to push deals automatically using WAP push means.

13. The system as claimed in claim 1, wherein the deal delivery means is adapted to send a deal using a web channel, said deal delivery means including
requesting means adapted to accept a request for deal information made by a user using a web interface; and
batch process means adapted to push deals automatically using a web push means.

14. The system as claimed in claim 1, wherein said deal delivery means comprises an external promotion facilitation unit including
registration means adapted to register 3^{rd} party interfaces including websites and blogs on said platform;
deal script generation means adapted to generate scripts to display deals on said 3^{rd} party interfaces; and
deal script trigger and display means adapted to display deals on 3^{rd} party interfaces on a user access trigger.

15. The system as claimed in claim 1, wherein said deal delivery means includes
social networking means adapted to promote deals using social networking and micro blogging sites like twitter, Facebook and orkut;
RSS/ATOM feeds facilitation means adapted to promote deals using RSS/ATOM feeds to be read by users using any standard feed reader;
instant messaging facilitation means adapted to promote deals using various instant messengers and internet relay chatting servers; and
plug-in support means adapted to promote deals via dedicated plug-in gadgets.

16. A method for promotional marketing for a group of persons comprising the following steps:
providing a virtual platform accessible by a group of users and a group of advertisers wherein the advertisers promote their services by selectively sending advertisements comprising deals through various channels to the users;
registering users on said platform via a remote device using the Internet or a mobile network through emails, SMS, or WAP;
validating said users;
storing the personal details and preferences set by users during registration, after validation;
registering advertisers on said platform via a remote device using the internet or a mobile network through emails, SMS, or WAP;
validating the advertisers;
enabling advertisers to select payment options including pricing models and credit limits and methods of paying for deals to be created;
facilitating the advertisers to create deals by advertising, selecting channels for promotion, and setting demographic and geographic preferences;
storing the deals created by various advertisers for further retrieval;
fetching data from said deal repository means and said user repository means;
matching the deal preferences and the preferences of users for effective promotion;
delivering deals to users after matching deal preferences and user preferences using channels selected by the advertisers;
enabling users to pay for the services in a cashless manner using tokens; and
tracking the deals between the users and the advertisers.

17. The method as claimed in claim 16, wherein the step of enabling user to pay for the services in a cashless manner includes using loyalty points for corporate users and further includes the following steps
tracking an employee's accumulated loyalty points;
using said accumulated points for payment; and
reconciling the payments with the employee at the end of the month.

18. The method as claimed in claim 16, wherein in the step of enabling a user to pay for services in a cashless manner includes using tokens for individual users and further includes the following steps:
valuing tokens; and
compensating the value of said tokens.

19. The method as claimed in claim 16, wherein the step of enabling a user to pay for the services in a cashless manner includes using a redemption code for credit/debit card users and includes the following steps:
generating a redemption code at the advertiser's retail store corresponding to a mobile coupon; and
entering the redemption code at the credit/debit card website for crediting the amount into the credit/debit card account.

20. The method as claimed in claim 16, wherein the step of enabling a user to pay for the services in a cashless manner is used for credit/debit card users and includes the following steps;
generating a redemption code at the advertiser's retail store corresponding to a mobile coupon containing a deal; and
entering the redemption code on the platform for crediting the amount into the credit/debit card account.
